(19) United States
(12) Patent Application Publication
(10) Pub. No.: US 2015/0298657 A1
(43) Pub. Date: Oct. 22, 2015

(54) method and device for controlling a cleaning apparatus for a vehicle camera, method for cleaning a vehicle camera and camera system for a vehicle

(71) Applicant: ROBERT BOSCH GMBH, Stuttgart (DE)

(72) Inventors: Pascal Kanter, Peissenberg (DE); Henning Voelz, Stuttgart (DE)

(73) Assignee: Robert Bosch GmbH, Stuttgart (DE)

(21) Appl. No.: 14/647,945

(22) PCT Filed: Dec. 3, 2013
(86) PCT No.: PCT/EP2013/075341

§ 371 Date: May 28, 2015

(30) Foreign Application Priority Data
Dec. 4, 2012 (DE) 10 2012 222 126.3

(51) Int. Cl. B60S 1/56; H04N 17/00; B60R 1/00; G02B 27/00

(52) U.S. Cl. CPC B60S 1/56; G02B 27/0006; H04N 17/002; B60R 1/00; B60R 2300/806

(57) ABSTRACT

A method for controlling a cleaning apparatus for a vehicle camera includes: a step of reading in image data that represent at least one image area of an image taken by the vehicle camera of a vehicle environment; a step of evaluating an image property of the at least one image area of the image in order to determine a soiling value of the vehicle camera; and a step of generating a control signal for controlling the cleaning apparatus as a function of the soiling value.

### BACKGROUND OF THE INVENTION

1. Field of the Invention

The present invention relates to a method for controlling a cleaning apparatus for a vehicle camera, a method for cleaning a vehicle camera, a device for controlling a cleaning apparatus for a vehicle camera, a camera system for a vehicle, as well as a corresponding computer-program product.

2. Description of the Related Art

Driver-assistance systems for assisting a driver to also, among other things, guide a vehicle when parking, are in series production. For example, one of the systems is a surround-view system which, with the aid of, e.g., four cameras, is able to suggest to the driver a view of his vehicle from above, so that the driver is able to move his vehicle in a virtual environment. For instance, in this case, one camera is located in each outside mirror, one is in the front and one is at the tail end of the vehicle. These cameras are not installed in the wiped area behind a windshield of the vehicle, and therefore are usually exposed unprotected to environmental or weather influences, e.g., soiling, wetting with drops of water, damage by stone impact and the like. In the case of modern vehicle cameras or camera systems for vehicles, an image quality is monitored autonomously by the system, for example. If, for instance, because of soiling, the image quality is no longer good enough to ensure a quality of a functionality based on camera images, this functionality is often degraded accordingly in order, for example, to prevent a malfunction. For instance, rearview cameras are often protected at least partially behind a flap, so long as the reverse gear is not engaged in the vehicle. However, this has the disadvantage that the images of the camera cannot be evaluated while the vehicle is traveling forward, which certainly is indispensable for some planned functions, e.g., for monitoring rear traffic.

### BRIEF SUMMARY OF THE INVENTION

According to specific embodiments of the present invention, soiling of a vehicle camera may be detected by evaluating an image quality, and thus cleaning, especially of the camera lens system, may be induced when necessary. In other words, a self-controlled cleaning activation is able to be provided for a vehicle camera or a camera system. To this end, for example, a control device or electronics of the vehicle camera evaluate an image quality of input images of the camera. If the image quality is too poor for a functionality, e.g., a driver assistance system, then instead of degrading the functionality, a cleaning apparatus is activated. The basic idea is that, in particular, the control device and/or the vehicle camera, e.g., a near-field camera, is able to decide itself when a cleaning is necessary.

Specific embodiments of the present invention advantageously make it possible to reduce soiling by environmental influences in the case of vehicle cameras or to remove it according to the need, and to keep a visual range of the cameras and thus their recorded images as clean as possible, so as to be able to improve availability of functions or functionalities based on the images. Compared to a design approach which degrades a functionality based on camera images, specific embodiments of the present invention offer the advantage that, in particular, such a functionality is able to operate continuously in full expression, with the exception of directly during the cleaning process, e.g., during cleaning by washer nozzles, or when soiling can no longer be removed by the cleaning system. In addition, a situation may advantageously be avoided where cleaning needs to be carried out continuously or constantly at certain time intervals, e.g., the situation may be avoided where a rearview camera needs to be covered by a flap briefly at certain fixed time intervals in order to clean the camera preventively. This has the advantage that a mechanism necessary for the cleaning is subject to less stress and a driver is disturbed less by noises possibly arising during the cleaning process. In addition, for example, considerably less cleaning fluid is consumed. Thus, specific embodiments of the present invention permit a demand-controlled cleaning of the vehicle camera. Therefore, unnecessary cleanings according to a fixed time pattern may be avoided, and a good cleansing state of the vehicle camera may be ensured.

An especially advantageous method for controlling a cleaning apparatus for a vehicle camera has the following steps:

read-in of image data that represent at least one image area of an image, taken by the vehicle camera, of a vehicle environment;
evaluation of an image property of the at least one image area of the image in order to determine a soiling value of the vehicle camera; and
generation of a control signal for controlling the cleaning apparatus as a function of the soiling value.

The vehicle camera may be mounted in or on a vehicle. In particular, the vehicle camera may be disposed in the area of a headlight, a taillight, an outside mirror or the like. The vehicle may be a motor vehicle, especially a road-going motor vehicle such as an automobile, a truck or other commercial vehicle. For example, the image data from the vehicle camera may also be made available at least to a driver assistance system and/or other image-based functionalities or applications. The cleaning apparatus may be designed to clean the vehicle camera in such a way that impairment of an image quality of images taken by the vehicle camera is prevented or at least reduced. There are several possibilities with regard to the cleaning of the vehicle camera when, for example, it is located apart from a windshield area wiped by windshield wipers. For example, the vehicle camera may be cleaned by a brush system and/or wiping system when protected or covered by a flap. Thus, cleaning by a protective device, cleaning by a headlight cleaning system if the vehicle camera is integrated in a headlight or taillight, and the like are also possible. Therefore, the cleaning apparatus may be an apparatus for the mechanical cleaning of the vehicle camera, the apparatus having cleaning elements with and/or without use of fluid. The image property may be an image quality dependent on a state of cleansing of the vehicle camera. The image property may deteriorate due to increasing soiling. Thus, a poor image property may be caused by a soiling value that represents a high degree of soiling of the vehicle camera. The control signal may be formed to induce cleaning of the vehicle camera by the cleaning apparatus as a function of the soiling value. If, in the evaluation step, a soiling value is determined that represents no soiling of the vehicle camera or soiling below a threshold value, generation of the control signal may be omitted or the control signal may be of a kind to prevent cleaning of the vehicle camera by the cleaning apparatus. The method for the control may also have a step of providing the control signal for controlling the cleaning apparatus at an interface to the cleaning apparatus.

According to one specific embodiment, in the evaluation step, image sharpness of the at least one image area of the image may be evaluated. Such a specific embodiment offers the advantage that the image property of image sharpness exhibits a direct dependency on soiling of the vehicle camera.

In the evaluation step, an actual value of the image property of the at least one image area of the image may also be compared to at least one threshold value of the image property in order to determine the soiling value of the vehicle camera, using a result of the comparison. The at least one threshold value of the image property may take a tolerance range of the image property into account. A first application-specific threshold value may be assigned to a usage of the image data by a first image-based practical application, and a second application-specific threshold value may be assigned to a usage of the image data by a second image-based practical application. Such a specific embodiment is advantageous because a practical decision criterion is available in the form of the threshold-value comparison, thus permitting a need-based cleaning of the vehicle camera.

In this connection, in the evaluation step, at least a first threshold value of the image property may be assigned to a first image area of the image, and at least a second threshold value of the image property, differing from the first threshold value, may be assigned to a second image area of the image. In so doing, the threshold values for the image areas may be a function of recognized objects in the respective areas. Such a specific embodiment offers the advantage that the degree of soiling of the vehicle camera may be recognized more reliably and accurately, since it permits concentration on meaningful image areas.

Moreover, a step of processing the image data may be provided in order to subdivide an image, represented by the image data, into a plurality of image areas, and to select the at least one image area for the evaluation step from the plurality of image areas. All image areas of the image represented by the image data may also be selected here for the evaluation step. The image may be subdivided into the image areas as a function of an object detection. Such a specific embodiment is advantageous in that it provides the basis for the ability to detect soiling of the vehicle camera even more exactly and reliably.

The steps of the method may also be repeated until a change in the soiling value of the vehicle camera satisfies a discontinuance criterion. The discontinuance criterion here may have a specified amount of a difference between a first soiling value from a first execution loop of the method and a second soiling value from a second execution loop of the method. Such a specific embodiment is advantageous because, when required, cleaning may be triggered repeatedly if the soiling value is liable to a change due to cleaning, and cleaning is discontinued when the soiling value no longer changes. Thus, an advantageous state of cleansing of the vehicle camera may be attained, accompanied by economical use of the cleaning apparatus.

An especially advantageous method for cleaning a vehicle camera has the following steps:

executing the steps of a version of the method indicated above; and
carrying out a cleaning process for cleaning the vehicle camera as a function of the control signal.

The method for cleaning may be carried out advantageously in conjunction with a version of the method indicated above for the control. In this context, prior to the step of carrying out the cleaning process, the method for the cleaning may also have the steps of a version of the method indicated above for the control.

An especially advantageous device for controlling a cleaning apparatus for a vehicle camera has the following features:

a unit for reading in image data that represent at least one image area of an image, taken by the vehicle camera, of a vehicle environment;
a unit for evaluating an image property of the at least one image area of the image in order to determine a soiling value of the vehicle camera; and
a unit for generating a control signal for controlling the cleaning apparatus as a function of the soiling value.

The device for the control may be part of the vehicle camera or part of a device provided separately from the vehicle camera. In the present case, a device may be understood to be an electrical device or control device that processes image data, and possibly threshold values of an image property, and outputs control signals as a function thereof. The device may have an interface which may be implemented in hardware and/or software. In the case of a hardware implementation, the interfaces may be part of what is termed a system ASIC, for example, that includes a wide variety of functions of the device. However, it is also possible that the interfaces are separate, integrated circuits or are made up at least partially of discrete components. In the case of a software implementation, the interfaces may be software modules which, for example, are available in a microcontroller in addition to other software modules.

A device for controlling a cleaning apparatus for a vehicle camera is designed to execute or implement the steps of a method indicated above for the control. In particular, the device may have units which are designed to carry out one step each of a method indicated above. The object of the present invention may be achieved quickly and efficiently by this embodiment variant of the invention in the form of a device, as well.

An especially advantageous camera system for a vehicle has the following features:

a vehicle camera;
a cleaning apparatus for cleaning the vehicle camera; and
a version of the device indicated above for controlling the cleaning apparatus.

A version of the device indicated above for the control may be employed or used advantageously in conjunction with the camera system. A version of the method indicated above for the control and/or a version of the method indicated above for the cleaning may also be carried out advantageously in conjunction with the camera system in order to control the cleaning apparatus and in order to clean the vehicle camera, respectively.

According to one specific embodiment, the cleaning apparatus may be designed to clean a lens or an optically transmissive camera cover of the vehicle camera. In this connection, a lens of the vehicle camera may be part of an external surface of the vehicle, or the lens may be situated adjacent to an external surface of the vehicle on a side of an optically transmissive section of the external surface of the vehicle facing away from a vehicle environment. For instance, the optically transmissive camera cover may be a headlight cover or the like, which acts here as camera cover, as well. Such a specific embodiment offers the advantage that a vehicle camera is also able to be cleaned when the vehicle camera is situated outside of a windshield of the vehicle.

Also advantageous is a computer-program product having program code which is stored in a machine-readable medium such as a semiconductor memory, a hard-disk storage or an optical memory, and is used to implement a method indicated above when the program is executed on a computer or in a device.

The invention is explained in greater detail by way of example with reference to the attached drawings.

### BRIEF DESCRIPTION OF THE DRAWINGS

FIG. 1 shows a schematic representation of a vehicle having a camera system according to one exemplary embodiment of the present invention.

FIGS. 2 and 3 show flowcharts of exemplary methods according to the present invention.

### DETAILED DESCRIPTION OF THE INVENTION

In the following description of preferred exemplary embodiments of the present invention, the same or similar reference numerals are used for the similarly functioning elements shown in the various figures, a repeated description of these elements being omitted.

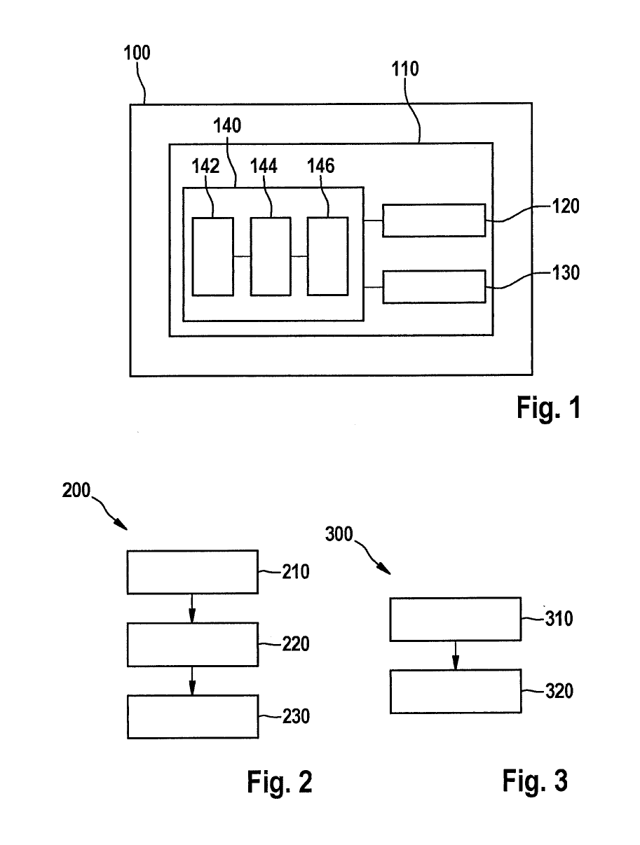

FIG. 1 shows a schematic representation of a vehicle 100 having a camera system 110 according to one exemplary embodiment of the present invention. Camera system 110 is situated in vehicle 100. Camera system 110 has a vehicle camera 120, a cleaning apparatus 130 for cleaning vehicle camera 120 and a control device 140 for controlling cleaning apparatus 130 or a device for controlling cleaning apparatus 130. Control device 140 has a read-in unit 142, an evaluation unit 144 and a generating unit 146.

Vehicle camera 120 of camera system 110 is designed to photograph an image of a vehicle environment of vehicle 100 and to generate image data which represent the image of the vehicle environment of vehicle 100. Vehicle camera 120 is connected to control device 140 with the aid of a communication interface, e.g., an electric line, a wireless connection or the like. Vehicle camera 120 is designed to provide the image data to control device 140. Although it is not shown in FIG. 1, vehicle camera 120 is also designed to provide the image data to further vehicle systems, e.g., driver assistance systems or the like.

Cleaning apparatus 130 of camera system 110 is disposed and designed to clean a lens or an optically transmissive cover of the lens of vehicle camera 120. Cleaning apparatus 130 is connected to control device 140 with the aid of a communication interface, e.g., an electric line, a wireless connection or the like. Cleaning apparatus 130 is designed to receive a control signal from control device 140. Cleaning apparatus 130 is also designed to clean vehicle camera 120 as a function of the control signal from control device 140.

Control device 140 is designed to control cleaning apparatus 130 for cleaning vehicle camera 120. Read-in unit 142 of control device 140 is designed to read in the image data from vehicle camera 120. Here, the image data represent at least one image area of an image, taken by vehicle camera 120, of an environment of vehicle 100. Evaluation unit 144 of control device 140 is designed to evaluate an image property of the at least one image area of the image in order to determine a soiling value of vehicle camera 120. Generating unit 146 of control device 140 is designed to generate a control signal for controlling cleaning apparatus 130 as a function of the soiling value determined by evaluation unit 140. Control device 140 is designed to output the control signal, generated by generating unit 146, to cleaning apparatus 130 in order to induce a cleaning of vehicle camera 120 as a function of the soiling value. Control device 140 may also be part of vehicle camera 120 or of cleaning apparatus 130, even though it is shown differently in FIG. 1.

FIG. 2 shows a flowchart of a method 200 for controlling a cleaning apparatus for a vehicle camera according to one exemplary embodiment of the present invention. Method 200 is executable in conjunction with a vehicle camera and a cleaning apparatus for cleaning the vehicle camera. Method 200 has a step 210 of reading in image data that represent at least one image area of an image, taken by the vehicle camera, of a vehicle environment. Method 200 also has a step 220 of evaluating an image property of the at least one image area of the image in order to determine a soiling value of the vehicle camera. In addition, method 200 has a step 230 of generating a control signal for controlling the cleaning apparatus as a function of the soiling value. Method 200 may be carried out advantageously in conjunction with the device or control device, especially the read-in unit, the evaluation unit and the generating unit from FIG. 1. The device, i.e., the units from FIG. 1, may be designed here to carry out the steps of method 200.

FIG. 3 shows a flowchart of a method 300 for cleaning a vehicle camera according to one exemplary embodiment of the present invention. Method 300 has a step 310 of executing the steps of the method from FIG. 2. Thus, execution step 310 may have sub-steps of read-in, evaluation and generation. Method 300 also has a step 320 of carrying out a cleaning process for cleaning the vehicle camera as a function of the control signal. The control signal is generated in step 310 of the execution of the steps of the method from FIG. 2. In other words, prior to step 320 of carrying out a cleaning process, method 300 also has the steps of the method from FIG. 2. Thus, method 300 for cleaning may be carried out advantageously in conjunction with the device or control device, the cleaning apparatus and the vehicle camera from FIG. 1. In addition, method 300 for the cleaning may be carried out advantageously in conjunction with the method for the control.

A camera system according to one exemplary embodiment of the present invention is described in summary again in different words with reference to FIGS. 1 through 3. Vehicle camera 120 is designed to monitor images, taken by it, for indications of soiling. For example, if an image quality of the camera images is poorer than a parameterizable value or threshold value—with separate values possibly being provided for various image-based applications—then cleaning of vehicle camera 120 is initiated by control device 140. To monitor the image quality, for instance, the image sharpness is monitored and evaluated by control device 140. Optionally, the image may be subdivided into different image areas and, for example, the image sharpness may be determined in each instance. If the image sharpness falls below a threshold value, the image quality is regarded as too poor. In particular, as an option, different image areas here have different threshold values since, for example, a blurred sky is less significant for certain image-based applications or functions than a fuzzily imaged street. For example, a fundamental idea is based here on the fact that vehicle camera 120 images in blurred fashion in an immediate close-up range, which means dirt and water drops that are directly on a camera lens are fuzzily imaged. If control device 140 decides that the image quality is not adequate and thus the soiling value is too high, the control signal may be provided via one of the common bus systems (e.g., CAN) to the cleaning device or cleaning apparatus 130, which then is able to clean accordingly. In the case of heavy soiling, e.g., a dead fly, method 300 for cleaning may also be repeated several times until the image quality for vehicle camera 120 is again satisfactory. If desired, vehicle camera 120 may be designed to degrade certain practical applications or functions which use image data of vehicle camera 120 if, after method 300 for cleaning has been carried out repeatedly, the image quality nevertheless continues to be too poor, e.g., in the case of a stone impact.

The exemplary embodiments described and illustrated in the figures are selected only by way of example. Different exemplary embodiments may be combined with each other completely or in terms of individual features. One exemplary embodiment may also be supplemented by features from another exemplary embodiment. Moreover, method steps may be repeated and executed in a sequence other than that described.

1-11. (canceled)

12. A method for controlling a cleaning apparatus for a vehicle camera, comprising:
(i) reading in image data representing at least one image area of an image of a vehicle environment taken by the vehicle camera;
(ii) evaluating an image property of the at least one image area of the image in order to determine a soiling value of the vehicle camera; and
(iii) generating a control signal for controlling the cleaning apparatus as a function of the soiling value.

13. The method as recited in claim 12, wherein in the step of evaluating the image property, an image sharpness of the at least one image area of the image is evaluated.

14. The method (200) as recited in claim 12, wherein in the step of evaluating the image property, an actual value of the image property of the at least one image area of the image is compared to at least one threshold value of the image property, and wherein the soiling value of the vehicle camera is determined using the result of the comparison.

15. The method as recited in claim 14, wherein in the step of evaluating the image property, at least a first threshold value of the image property is assigned to a first image area of the image, and at least a second threshold value of the image property differing from the first threshold value is assigned to a second image area of the image.

16. The method as recited in claim 12, wherein the at least one image area is selected from a plurality of image areas of the image generated by subdividing the image.

17. The method as recited in claim 12, wherein the steps (i), (ii), and (iii) of the method are repeated until a change in the soiling value of the vehicle camera satisfies a predefined discontinuance criterion.

18. The method as recited in claim 14, further comprising:
carrying out a cleaning process for cleaning the vehicle camera as a function of the control signal.

19. A device for controlling a cleaning apparatus for a vehicle camera, comprising:
a unit for reading in image data representing at least one image area of an image of a vehicle environment taken by the vehicle camera;
a unit for evaluating an image property of the at least one image area of the image in order to determine a soiling value of the vehicle camera; and
a unit for generating a control signal for controlling the cleaning apparatus as a function of the soiling value.

20. A camera system for a vehicle, comprising:
a vehicle camera;
a cleaning apparatus for cleaning the vehicle camera; and
a control device for controlling the cleaning apparatus, including:
a unit for reading in image data representing at least one image area of an image of a vehicle environment taken by the vehicle camera;
a unit for evaluating an image property of the at least one image area of the image in order to determine a soiling value of the vehicle camera; and
a unit for generating a control signal for controlling the cleaning apparatus as a function of the soiling value.

21. The camera system as recited in claim 20, wherein the cleaning apparatus is configured to clean one of a lens or an optically transmissive camera cover of the vehicle camera.

22. A non-transitory, computer-readable data storage medium storing a computer program having program codes which, when executed on a computer, performs a method for controlling a cleaning apparatus for a vehicle camera, the method comprising:
(i) reading in image data representing at least one image area of an image of a vehicle environment taken by the vehicle camera;
(ii) evaluating an image property of the at least one image area of the image in order to determine a soiling value of the vehicle camera; and
(iii) generating a control signal for controlling the cleaning apparatus as a function of the soiling value.
